(19) United States
(12) Patent Application Publication
(10) Pub. No.: US 2006/0010946 A1
(43) Pub. Date: Jan. 19, 2006

(54) Pelleted organic calcium phosphate compositions

(75) Inventors: Lawrence Mayhew, Spring Green, WI (US); Donald Faber, Fitchburg, WI (US); Gary Zimmer, Spring Green, WI (US)

Correspondence Address: MICHAEL BEST & FRIEDRICH, LLP, ONE SOUTH PINCKNEY STREET, P O BOX 1806, MADISON, WI, 53701, US

(73) Assignee: Midwestern Bio-Ag Products & Services, Inc., Blue Mounds, WI (US)

(21) Appl. No.: 10/891,920

(22) Filed: Jul. 15, 2004

(51) Int. Cl. C05F 11/02

(52) U.S. Cl. 71/24

(57) ABSTRACT

The present invention provides a method of producing a pelletized composition containing leonardite, sedimentary rock and gypsum. The method calls for pre-mixing the humic substance and the sedimentary rock for at least two weeks to yield a developed mixture prior to addition of other materials such as gypsum and pelletizing and drying the pellets to produce the final product. The invention also includes several pelleted compositions containing leonardite, rock phosphate and gypsum. In one aspect of the invention the rock phosphate comprises a mixture of sedimentary rock phosphate and igneous rock phosphate. In another aspect of the invention, the igneous rock phosphate comprises carbonatite and the sedimentary rock phosphate comprises phosphorite.

### CROSS-REFERENCE TO RELATED APPLICATIONS

None

### FIELD OF THE INVENTION

The present invention relates to compositions of organic fertilizers for use in a variety of potential applications including soil enhancers, plant fertilizers and livestock feed additives. In particular, the invention relates to a method of pre-mixing humic substances with sedimentary rock and forming a pelleted, low-dust composition.

Current agricultural practices are diverging into two broad categories: conventional and biological (organic).

Conventional agriculture relies primarily on man-made soluble chemicals to replace a limited number of soil minerals by direct foliar or soil application. Biological (organic) agriculture uses a variety of complex natural inputs and management practices to improve the physical, chemical and biological properties of the soil and does not allow the use of synthetic substances as part of the agricultural process.

The term “organic” was adopted by the United States Department of Agriculture to describe a system of agriculture that complies with federal regulations set forth in the National Organic Program (National Organic Program, 2000, National Archives and Records Administration, Federal Register, Part IV, Department of Agriculture, Agricultural Marketing Service, 7 CFR Part 205, National Organic Program; Final Rule). Only a few organic fertilizers are currently available. In either application, the ideal fertilizer should be a balance of immediately available and slow-release nutrients. Therefore, there is a need for fertilizers that are environmentally stable for use in both conventional and organic agriculture.

Humic substances are probably the most versatile of all organic compounds, because of their ability to solubilize, complex and chelate natural minerals. Their use in agriculture is expanding rapidly, particularly in organic agriculture, because of their ability to stabilize nutrients. Humic substances are generally accepted as improving the efficiency of fertilizers and positively impact overall crop quality. Addition of humic substances to fertilizers also reduces the reliance on nitrogen and reduces the environmental impact of agriculture. The most common source of humic substances is a naturally occurring ore associated with coal deposits called leonardite in the United States, humalite in Canada, or oxidized lignite. However, the colloidal size of humic substances (<2 microns) is responsible for the production of large quantities of dust during handling of the materials. Attempts to improve the handling characteristics of natural humic materials include liquefaction and pelletization.

Liquefaction of humic substances can be achieved via various methods that are well-known in the art. All known methods of liquefaction require alkali and acid extraction of the humic substances. The extraction process results in three fractions: humic acid, fulvic acid and humin. These fractions are operationally defined and chemical analysis of the separate fractions is not completed. Therefore, little is known of the available nutrients present in each of the fractions or whether nutrient loss occurs as a result of the fractionation process. The United States Department of Agriculture currently allows the use of humic acid and fulvic acid in organic agriculture, but there is debate about the future acceptance of these synthetic products as they are prohibited on crops grown for export to, e.g., Japan (OMRI, 2004. Generic Materials List, June 2004. Organic Materials Review Institute, Eugene, Oreg.). Complete, natural humic substances may also contain other desirable characteristics such as trace minerals that may be lost during extraction and fractionization. For instance, slight changes in pH cause the humic polymers to fracture and break up. These alterations likely result in the liquid fractions having lower available beneficial nutrients than the humic substances as a whole. Liquid fertilizers are also limited to foliar application, have no ability to improve the soil environment and do not provide any slow-release nutrients. The liquid extracts are easier to handle, but the extraction process is expensive and this limits the applicability to high value crops and small garden plots.

Pelletizing humic substances with natural materials could overcome the above-mentioned drawbacks by preserving all of the natural ingredients in the raw ore and improving the handling characteristics of the humic substances. The currently available pellets generally produced by combining humic substances with conventional soluble fertilizers still result in a dusty pellet that is not easy to handle, but increases the fertilizer's efficiency. For example, a combination of conventional soluble fertilizer with leonardite as a pelletized product has been shown to improve the efficiency of the fertilizer and impact overall crop quality (Cooley, A. M., Douglas, G., Rasmussen, W. H., Rasmussen, J. J. and Theis, J., 1967. Leonardite in Fertilizer. In: Information Circular 8471, Bureau of Mines, United States Department of the Interior, pp. 158-164). Similar results were obtained by blending leonardite with sodium humate and caustic soda ash (Townley, U.S. Pat. No. 5,656,060) and by fusing coal ash with leonardite after activation with potassium hydroxide (Trowbridge, U.S. Pat. No. 5,451,240). None of these methods are acceptable for organic agriculture because they rely on materials that the National Organic Program excludes. Generally, these methods also require direct heat drying of the pelletized material at temperatures above 200° C. Such high heat causes the loss of phenolic and carboxylic functional groups from the humic substance and will reduce or destroy its effectiveness and biological activity (Schnitzer, M. and Khan, S. U., 1972. Humic Substances in the Environment. Marcel Dekker, New York, p. 112).

### SUMMARY OF THE INVENTION

The present invention provides a method of producing a pelletized low-dust composition comprising a humic substance, suitably leonardite, a sedimentary rock and gypsum for use in a variety of plant and livestock applications. The method includes pre-mixing the humic substance and the sedimentary rock to yield a developed mixture prior to addition of other materials, such as gypsum, and pelletizing and drying the pellets to produce the final product.

According to the present invention, the foregoing and other advantages are attained by producing a pelleted composition by first mixing sedimentary rock phosphate with a humic substance, suitably leonardite, and allowing the mixture to develop. The development period is suitably at least two weeks. Then, an igneous rock phosphate, gypsum, a binder and water are added and uniformly mixed. The resulting mixture is pelletized and finally dried until the moisture content of the pellet is less than or equal to 8%.

In another aspect of the present invention, a pelleted composition is produced by combining limestone with a humic substance, suitably leonardite, and allowing it to develop for at least two weeks. Then, the developed limestone-humic substance mixture is combined with gypsum, a binder and water and is mixed until uniform. The resulting mixture is pelletized and dried until the moisture content is less than or equal to 8%.

In yet another aspect of the present invention, a stable pelleted composition is produced by combining a humic substance, suitably leonardite, with an amendment selected from the group consisting of limestone or sedimentary rock phosphate to yield a mixture that is allowed to develop for at least two weeks. The developed mixture is further combined with gypsum and an aqueous binder in an amount sufficient to bind the developed mixture to yield a resultant mixture. Finally, the resultant mixture is pelletized and the pellets are dried at a temperature of less than about 200° C.

Another aspect of the present invention is a composition in the form of a pellet comprising gypsum, limestone and a humic substance, suitably leonardite. These pellets are substantially dust-free. The pellet can also comprise a binder, suitably calcium lignosulfate. The pellet can also comprise calcium.

In yet another aspect of the present invention the pellet is comprised of gypsum, rock phosphate and a humic substance, suitably leonardite. This pellet is also substantially dust-free. In one aspect of the invention, the rock phosphate comprises a mixture of sedimentary rock phosphate and igneous rock phosphate. In another aspect of the invention, the igneous rock phosphate comprises carbonatite and the sedimentary rock phosphate comprises phosphorite.

The methods and the compositions described effectively produce a pelleted organic product that provides both immediately available and slow-release nutrients to the soil, plants and animals.

### BRIEF DESCRIPTION OF DRAWINGS

FIG. 1 depicts the reaction of the ingredients prior to pelletizing.

FIG. 2 depicts one route for the pelletizing process.

FIG. 3 provides sampling data for Example 1 of the application.

FIG. 4 shows available phosphorous in various sedimentary rock compositions of Example 1 of the application

Before the embodiments of the invention are explained in detail, it is to be understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof.

### DETAILED DESCRIPTION OF THE INVENTION

The present invention relates to compositions and methods of making compositions for use in a variety of potential applications including soil enhancers, plant fertilizers and livestock feed additives. In particular, the invention relates to a method of pre-mixing humic substances with sedimentary rock and forming a pelleted, low-dust composition.

Both sedimentary and igneous rock phosphates are used as the basic material from which almost all phosphatic fertilizers are manufactured. Conventional manufacturing processes use strong reagents, such as sulfuric and phosphoric acid, to generate highly soluble phosphate fertilizers. Because of the environmental impact of the by-products, synthetic phosphate fertilizers are prohibited in organic crop production and usually avoided in biological agriculture.

It is generally accepted that naturally occurring mineral apatites (rock phosphates) from sedimentary deposits have various amounts of soluble phosphate. Sedimentary and igneous deposits are usually insoluble with little or no “available” phosphate as plant fertilizer. The present invention increases the soluble (available) phosphate in a sedimentary rock phosphate by the addition of a humic rich substance, specifically leonardite. Leonardite is an oxidized (weathered) lignite coal, which may contain as much as 70 to 80% humic substances.

By pre-mixing the sedimentary rock with the humic substances the current invention allows a natural acidification of the rock. Allowing the mixture of humic substances, e.g., leonardite, and sedimentary rock to digest for at least two weeks, surprisingly resulted in greatly increased immediate bioavailability of the nutrients. This immediately available calcium and phosphate aids in triggering the microbial priming effect that, along with the humic substances, aid in the continued release of nutrients from the remaining insoluble minerals. Mixing of the humic substance with sedimentary and/or igneous rock also resulted in a more stable pelletized product that was less dusty compared to prior art pellets. The resulting pelletized compositions are environmentally safe, easy to handle and contain a balance of immediately available and slow-release calcium, phosphate and other trace minerals.

Humic substances are natural complex organic materials that are acidic (about pH 3.4 to pH 4.1) and can solubilize phosphate rock. Because humic substances chelate cations (especially Ca²⁺) and complex with phosphate (P0₄³⁻) anions, the bioavailability of phosphate rock can be increased with little or no environmental impact.

The term “humic substance” is used herein in a generic sense to distinguish the natural material from its fractions, namely humic acid, fulvic acid and humin. The predominant source of humic substances is leonardite, a naturally occurring ore found associated with coal deposits. Leonardite is also known as humate, brown coal, lignite, slack lignite, oxidized lignite, weathered lignite, humic shale, humalite, carbonaceous shale, colloidal minerals, concentrated humus, humus coal, or dead organic matter. Leonardite is a complex mixture of high and low molecular weight humic substances. The lower molecular weight constituents—generally referred to as fulvic acids—are primarily responsible for the solubilization of phosphate minerals. The higher molecular weight components—known as the humic acids—are also engaged in solubilizing minerals and have a high capacity for stimulating biological activity and great potential for chelation. In natural soil systems, the two components act synergistically.

In the present invention, the humic substance leonardite is mixed with a sedimentary rock. Several different types of sedimentary rock may be utilized. For instance, limestone—which is also known as calcite, high-calcium limestone, lime, Pearl Spar, calcitic limestone, or aragonite—is a very common sedimentary rock consisting primarily of calcium carbonate in the form of either calcite or aragonite. Aragonite, which is the polymorph of calcite, has the same chemical composition as calcite. Limestone can consist of 32-40% calcium and is used as a calcium source in the present invention.

When the amount of magnesium in sedimentary limestone exceeds 3% by weight, it is referred to as dolomite or dolomitic limestone. Dolomitic limestone (dolomite) is also a very common rock, and it consists primarily of calcium magnesium carbonate. It can contain about 22% calcium, and commercially available sources typically have 8-10% magnesium. Dolomite serves as a source of both calcium and magnesium in the present invention. The igneous form of dolomite, known as rauhaugite, may also be used in the present invention.

The sedimentary rock phosphate may also be used as a source of phosphorus. The phosphorites are sedimentary phosphate deposits with a high concentration of phosphates. They are generally found in compacted masses consisting predominantly of apatite and other phosphates. Typically, phosphorite beds contain about 30% phosphorus pentaoxide. Phosphorites constitute the primary industrial source of raw materials for phosphate-based fertilizers.

Other sedimentary rock phosphates may be known as phosphate rock, soft rock phosphate, hard rock phosphate, or colloidal rock phosphate. These are geological rock deposits made up largely of inorganic phosphates, commonly calcium phosphate, in the form of the mineral series apatite. Fluorapatite, chlorapatite and hydroxylapatite are the most common apatite minerals found in natural phosphate deposits.

The term “rock phosphate” or “phosphate rock” is used herein to describe naturally occurring geological materials that contain sufficient phosphate minerals for commercial utilization. The term “available phosphate” refers to the presence of a soluble form of phosphate. The concentration of phosphorus in the rock minerals is expressed as an equivalent of phosphorus pentaoxide. The amount of phosphorus pentaoxide found in commercially viable natural minerals may vary from 12% to as high as 42% by weight.

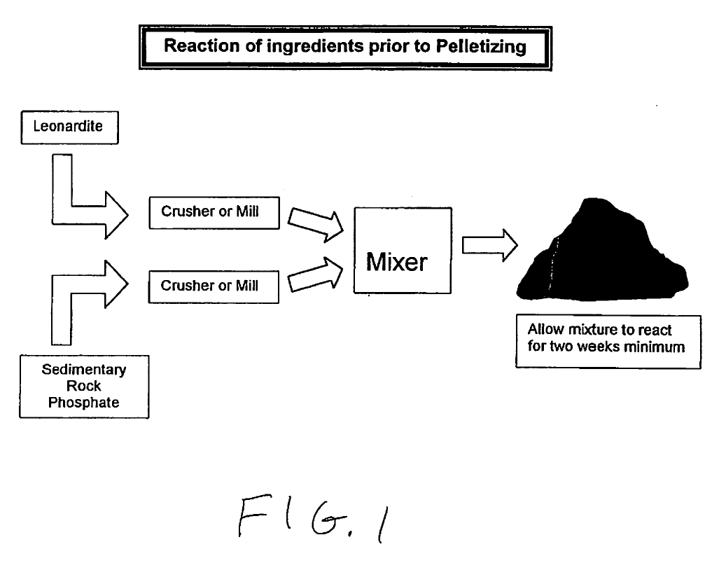

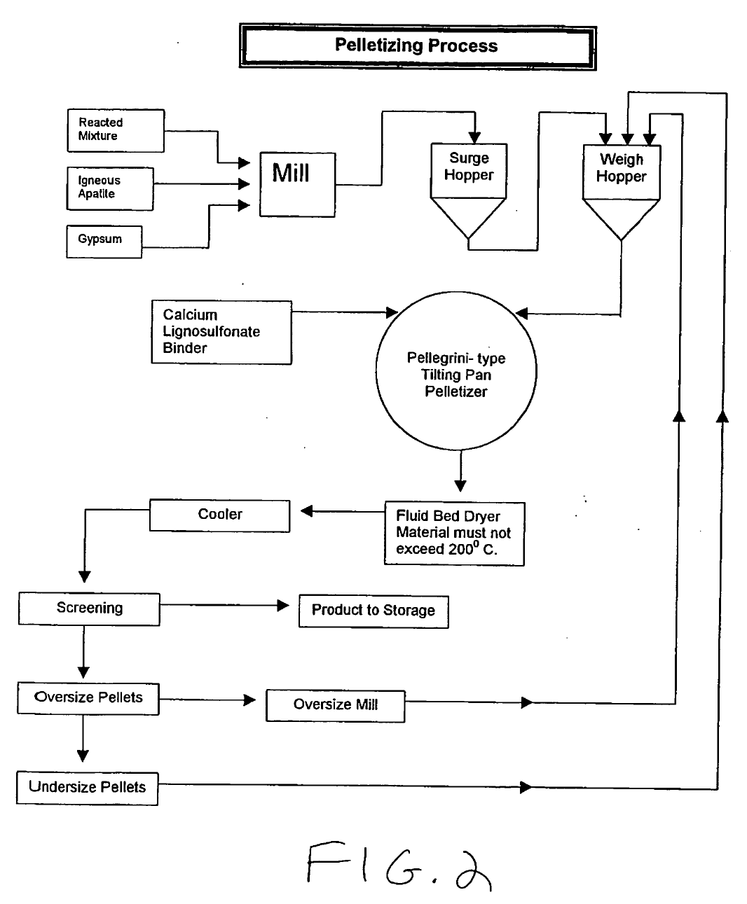

As shown in FIGS. 1 and 2 the sedimentary rock and the leonardite are finely ground prior to pre-mixing and are allowed to rest for development periods suitably at least two weeks prior to mixing with other substances and pelletizing to form the finished product. Another substance that may be added to the combination of leonardite and sedimentary rock phosphate is gypsum. Gypsum is a common form of sedimentary evaporative mineral and it consists primarily of hydrated calcium sulfate. Gypsum is approximately 22% calcium and 17% sulfur. Gypsum may also occur naturally from the reaction of sulfuric acid on limestone in volcanic areas, or from secondary hydration of the anhydrite form of calcium sulfate. Gypsum is used as a source of both calcium and sulfur in the present invention.

Yet another substance that may be combined to the leonardite sedimentary rock mixture is igneous rock. Igneous rocks are formed from volcanic activity and may provide an additional source of phosphate in the present invention. One form of igneous rocks used in the present invention is carbonatite.

Once the components are mixed together, a binder can be added. One binder used in the present invention is calcium lignosulfate. Other similar binders, such as bentonite, may also be used and are known to those skilled in the art.

Finally, water may be added to the mixture in order to pelletize the mixture and obtain a low-dust pellet. Pelletizing occurs via a mechanism described in, or similar to the mechanism described in, Cooley, A. M., Douglas, G., Rasmussen, W. H., Rasmussen, J. J. and Theis, J., 1967. Leonardite in Fertilizer. In: Information Circular 8471, Bureau of Mines, United States Department of the Interior, pp. 158-164 and is incorporated herein. The low-dust pellet produced provides an efficient means of imparting minerals for a variety of agricultural uses, with both immediately available and slow-release nutrients.

In one aspect of the invention, the pellet comprises gypsum, limestone and leonardite.

The gypsum can comprise about 10% to about 40% by weight of the pellet, more suitably comprise about 15% to about 35% by weight of the pellet, even more suitably comprise about 20% to about 30% by weight of the pellet, and even more suitably comprise about 25% by weight of the pellet.

The limestone can comprise about 10% to about 40% by weight of the pellet, more suitably comprise about 15% to about 35% by weight of the pellet, even more suitably comprise about 20% to about 30% by weight of the pellet, and even more suitably comprise about 25% by weight of the pellet.

The leonardite can comprise about 20% to about 80% by weight of the pellet, more suitably comprise about 40% to about 60% by weight of the pellet, and even more suitably comprise about 50% by weight of the pellet. Suitably the leonardite can contain from about 60% to about 80% humate by weight of the leonardite, and more suitably about 70% humate.

The pellet can also comprise a binder, suitably calcium lignosulfate. The calcium lignosulfate can suitably comprise about 0.5% to about 2% by weight of the pellet.

The pellet can also comprise calcium. In one aspect, the calcium can comprise at least 15%, more suitably at least 18%, and even more suitably at least 20% by weight of the pellet.

In another aspect of the invention, a pellet is provided which comprises gypsum, rock phosphate and leonardite. In one aspect of the invention, the rock phosphate comprises a mixture of sedimentary rock phosphate and igneous rock phosphate. In another aspect of the invention, the igneous rock phosphate comprises carbonatite and the sedimentary rock phosphate comprises phosphorite.

In this aspect of the present invention, the pellet is comprised of about 10% to about 30% by weight gypsum; about 40% to about 60% by weight sedimentary rock phosphate; about 1% to about 20% by weight igneous rock phosphate; about 10% to about 30% by weight leonardite; and about 0.5% to about 2.0% by weight calcium lignosulfate.

The leonardite of the pellet comprises humic acid from about 60% to about 80% by weight of the leonardite, and more suitably 70% by weight.

Suitably, the pellet can be comprised such that the total phosphate comprises from about 10% to about 20% by weight of the pellet, and more suitably comprises total phosphate of about 15% by weight of the pellet. Furthermore, the available phosphate suitably comprises from about 0.5% to about 10% by weight of the composition, more suitably comprises from about 1% to about 8% by weight of the composition, and even more suitably comprises about 5% by weight of the composition.

The present invention is further explained by the following examples, which should not be construed to limit the scope of the present invention.

### EXAMPLE 1

### Increasing Available Phosphate in a Rock Phosphate

Sedmentary rock phosphate was obtained in the form of was Tennessee Brown Rock (TBR) phosphate. The humic substance (HS) was obtained in the form of Falkirk Leonardite. Both materials were obtained from uncovered outdoor stock piles at the Harvey Products, Inc. facility in Harvey, Iowa.

TBR is received at the Harvey facility as a crushed, washed and screened ore with a typical moisture content of 15 to 20%.

The humic substances (HS) were received as a raw uncrushed leonardite ore from the Falkirk Mining Company in Underwood, N. Dak. It was crushed, but not screened, to approximately ¾ inch minus prior to being used in production. The moisture content of the leonardite ore was in the range of 25% to 40%. The humic acid content was about 50%, total carbon of about 33%, ash about 30% and CEC about 180.

The control was untreated TBR. The first three mixtures were prepared by pouring them back and forth into two five-gallon plastic buckets. The action was intended to mimic the action of the industrial mixers. Mixtures #1 and #2 consisted of Tennessee Brown Rock phosphate combined with humic substances in ratios of 2:1 and 3:1 respectively, by weight. The humic substances were crushed (¾ inch minus) Falkirk Leonardite. The weight of each mixture was approximately 30 pounds.

Mixture #3 was a 3:1 ratio mix using screened Leonardite. A #5 mesh screen (4.00 mm, 0.157 inch) was used to screen the Leonardite. Forty-five pounds of crushed Leonardite yielded 31 pounds of screened material and 14 pounds of oversize material.

Two buckets of each of the above mixtures were made. One set of the 30-pound mixtures was treated with rainwater on a regular basis to mimic outdoor storage conditions.

Samples were taken at various day intervals. The elapsed time from the moment of sampling to the moment of analysis was variable. For example, the 14 and 21-day-old samples were both 28 days old by the time they were analyzed. Each sample was analyzed for available phosphate and moisture content.

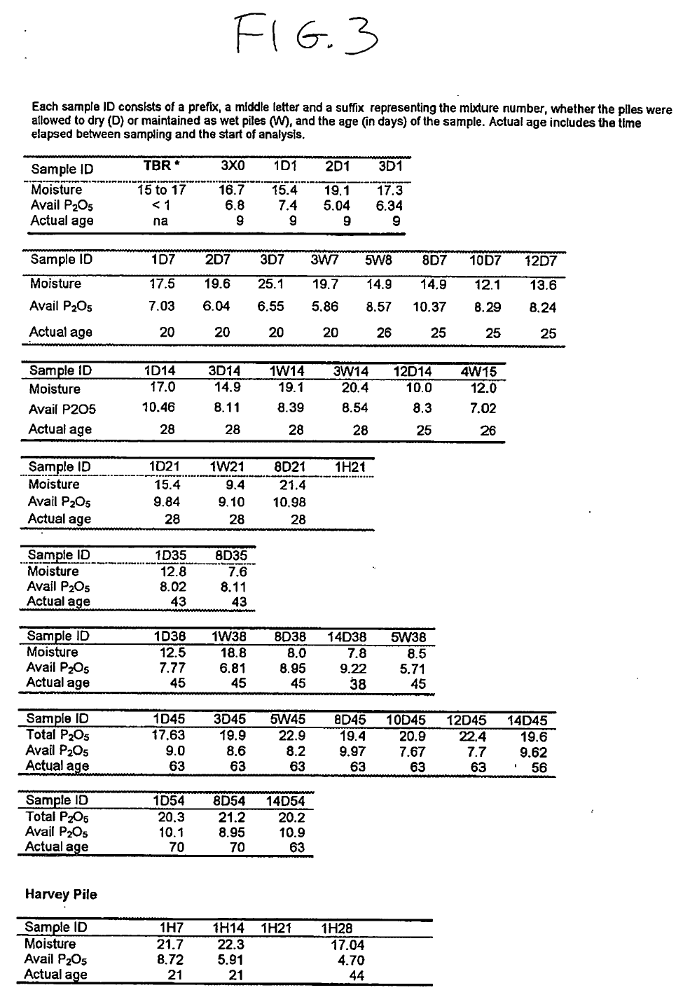

Various combinations and conditions were set up. Some piles received water treatment in order to maintain the moisture content in the piles, while other piles were allowed to dry. The size of the Leonardite was also a variable in that some piles had ¾″ minus Leonardite and others had #5 screened Leonardite (see Table 1 and FIG. 3). The ratios of Tennessee Brown Rock phosphate to humic substances was either 3:1 or 2:1 by weight combinations of volcanic ore and elemental sulfur showed no appreciable affect at fourteen days, so they were sampled at wider intervals.

TABLE 1
Mixture Data Sheet

| | Date | | | Ratio | VCP | Sulfur |
|---|---|---|---|---|---|---|
| Mixture # | Mixed | Conditions | Size of HS | TBR:HS | added | added |
| Control | — | D | — | — | — | — |
| 1 | Jul. 8, 2003 | D | ¾″ | 2:1 | — | — |
| 2 | Jul. 8, 2003 | D | ¾″ | 3:1 | — | — |
| 3 | Jul. 8, 2003 | D | #5 | 3:1 | — | — |
| 1w | Jul. 8, 2003 | W | ¾″ | 2:1 | | |
| 2w | Jul. 8, 2003 | W | ¾″ | 3:1 | | |
| 3w | Jul. 8, 2003 | W | #5 | 3:1 | | |
| 4 | Jul. 10, 2003 | W | #5 | 3:1 | — | 2% |
| 5 | Jul. 10, 2003 | W | #5 | 3:1 | 5% | — |
| 6 | Jul. 10, 2003 | D | #5 | 2:1 | — | 5% |
| 7 | Jul. 11, 2003 | D | #5 | 3:1 | — | 2% |
| 8 | Jul. 11, 2003 | D | #5 | 2:1 | — | — |
| 9 | Jul. 11, 2003 | W | #5 | 3:1 | — | 2% |
| 10 | Jul. 11, 2003 | 0 | #5 | 3:1 | — | 1% |
| 11 | Jul. 11, 2003 | W | #5 | 3:1 | — | 1% |
| 12 | Jul. 11, 2003 | D | #5 | 3:1 | 5% | 1% |
| 14 | Jul. 15, 2003 | D | #5 | 2:1 | — | — |
| Harvey Pile | Jul. 15, 2003 | H | ¾″ | 2:1 | — | — |

D = as received from stockpile (damp)
W = additional water added to pile
HS = humic substances
VCP = igneous ore

A 2:1, ¾″ minus mixture was made at the Harvey, Iowa facility and labeled Harvey Pile (H). It was mixed on-site using the material handling equipment that is normally used for production at the facility.

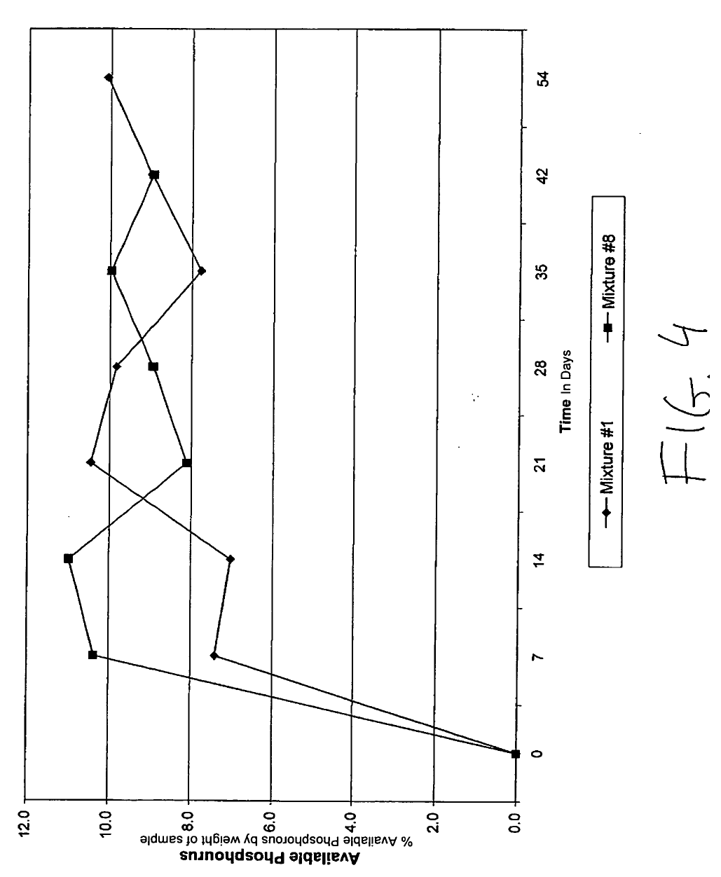

All samples demonstrated an increase in available P₂O₅ immediately after mixing (see FIG. 3). FIG. 3 shows the days the samples were allowed to rest, the percentage of water in the samples by weight of the sample, and the percentage of P₂O₅ by weight of the sample. The available P₂O₅ continued to increase as a function of time, reaching a maximum soluble amount at about 28 days (see FIG. 4). After that, the amount of soluble P₂O₅ decreased. The decrease in the soluble fraction may be the result of the (PO₄)³⁻ reacting with unknown species, obtaining equilibrium with other cations in the mixture or reverting to its original species.

There was no correlation between moisture content and the amount of phosphate released. However, there was a correlation to particle size and availability (FIG. 4). Mixture #1 and #8 differed only in the particle size of the Leonardite.

The Leonardite in mixture #1 was crushed to approximately ¾″ but unscreened. The Leonardite in mixture #8 was obtained by screening the ¾″ crushed material with a #5 screen. The screened material provided a more homogenous mixture, which may have resulted in an increase in overall contact with the rock phosphate. The maximum concentration of available phosphate occurred sooner and decreased sooner than the crushed, unscreened material.

The actual age of the material from the time of mixing to the time of analysis is noted in FIG. 4.

### EXAMPLE 2

### Method of Generating a Pellet Composition

To generate a composition that is high in available calcium, limestone is used as the sedimentary rock. Components are ground and passed through a #5 mesh screen. The limestone is then pre-mixed with the leonardite in a 1:2 ratio by weight and this mixture is allowed to develop for at least two weeks. An amount of gypsum approximately equivalent to the limestone by weight is mixed into the leonardite-limestone mix and finally a binder such as calcium lignosulfate is added. The mixture is pelletized using standard procedures that are well-known in the art and dried at a temperature of less than about 200° C.

### EXAMPLE 3

### Method of Generating a Pellet Composition

To generate a composition that is high in available phosphate, a rock phosphate such as Tennessee Brown Rock is used as the sedimentary rock. As in example 2, the components are ground and passed through a #5 mesh screen. The sedimentary rock phosphate and the leonardite are pre-mixed in a 2:1 ratio by weight for two weeks to allow development. Gypsum is added in an amount equivalent to the leonardite by weight and approximately half as much igneous rock phosphate is also added. Finally a binder such as calcium lignosulfate and water are added to aid in the pelletization process. After pelletization by processes well-known in the art, the pellets are dried until the moisture content is less than or equal to 8% at a temperature of less than about 200° C.

While the present invention has now been described and exemplified with some specificity, those skilled in the art will appreciate the various modifications, including variations, additions, and omissions, that may be made in what has been described. Accordingly, it is intended that these modifications also be encompassed by the present invention and that the scope of the present invention be limited solely by the broadest interpretation lawfully accorded the appended claims.

All patents, publications and references cited herein are hereby fully incorporated by reference. In case of conflict between the present disclosure and incorporated patents, publications and references, the present disclosure should control.

1. A composition comprising a pellet which comprises gypsum, limestone and a humic substance.

2. The composition of claim 1 wherein the humic substance is leonardite.

3. The composition of claim 2, wherein the gypsum comprises from about 10% to about 40% by weight of the composition.

4. The composition of claim 3, wherein the gypsum comprises from about 20% to about 30% by weight of the composition.

5. The composition of claim 4, wherein the gypsum comprises about 25% by weight of the composition.

6. The composition of claim 2, wherein the limestone comprises from about 10% to about 40% by weight of the composition.

7. The composition of claim 6, wherein the limestone comprises from about 20% to about 30% by weight of the composition.

8. The composition of claim 7, wherein the limestone comprises about 25% by weight of the composition.

9. The composition of claim 2, wherein the leonardite comprises from about 20% to about 80% by weight of the composition.

10. The composition of claim 9, wherein the leonardite comprises from about 40% to about 60% by weight of the composition.

11. The composition of claim 10, wherein the leonardite comprises about 50% by weight of the composition.

12. The composition of claim 2, wherein the limestone is dolomitic limestone or high calcium limestone, or combinations thereof.

13. The composition of claim 2, wherein the leonardite comprises from about 60% to about 80% humate.

14. The composition of claim 13, wherein the leonardite comprises about 70% humate.

15. The composition of claim 1, further comprising a binder.

16. The composition of claim 15, wherein the binder is calcium lignosulfate.

17. The composition of claim 1 which comprises at least 15% by weight calcium.

18. The composition of claim 17 which comprises at least 18% by weight calcium.

19. The composition of claim 1, wherein the pellet is substantially dust-free.

20. A composition comprising a pellet which comprises:
a) about 15% to about 35% by weight gypsum;
b) about 15% to about 35% by weight limestone;
c) about 40% to about 60% by weight leonardite; and
d) about 0.5% to about 2.0% by weight calcium lignosulfate.

21. A composition comprising a pellet which comprises gypsum, rock phosphate and a humic substance.

22. The composition of claim 21 wherein the humic substance is leonardite.

23. The composition of claim 22, wherein the rock phosphate comprises a mixture of sedimentary rock phosphate and igneous rock phosphate.

24. The composition of claim 23, wherein the sedimentary rock phosphate comprises phosphorite.

25. The composition of claim 23, wherein the igneous rock phosphate comprises carbonatite.

26. The composition of claim 22, wherein the gypsum comprises from about 10% to about 30% by weight of the composition.

27. The composition of claim 23, wherein the sedimentary rock phosphate comprises from about 40% to about 60% by weight of the composition.

28. The composition of claim 23, wherein the igneous rock phosphate comprises from about 1% to about 20% by weight of the composition.

29. The composition of claim 22, wherein the leonardite comprises from about 10% to about 30% by weight of the composition

30. The composition of claim 22, wherein the leonardite comprises from about 60% to about 80% humate.

31. The composition of claim 30, wherein the leonardite comprises about 70% humate.

32. The composition of claim 21, further comprising a binder.

33. The composition of claim 32, wherein the binder is calcium lignosulfate.

34. The composition of claim 22 which comprises at least 15% by weight calcium.

35. The composition of claim 34 which comprises at least 20% by weight calcium.

36. The composition of claim 21, wherein the pellet is substantially dust-free.

37. The composition of claim 22 wherein total phosphate comprises from about 10% to about 20% by weight of the composition.

38. The composition of claim 22 wherein total phosphate comprises about 15% by weight of the composition.

39. The composition of claim 22 wherein available phosphate comprises from about 0.5% to about 10% by weight of the composition.

40. The composition of claim 9 wherein the available phosphate comprises from about 1% to about 8% by weight of the composition.

41. The composition of claim 11 wherein the available phosphate comprises about 5% by weight of the composition.

42. A composition comprising a pellet which comprises:
a) about 15% to about 25% by weight gypsum;
b) about 45% to about 55% by weight sedimentary rock phosphate;
c) about 5% to about 15% by weight igneous rock phosphate;
d) about 15% to about 25% by weight leonardite; and
e) about 0.5% to about 2.0% by weight calcium lignosulfate.

43. A method of producing a pelleted composition comprising:
i. uniformly mixing a mixture comprising:
a) a combination of sedimentary rock phosphate and leonardite which has been developed for at least two weeks;
b) igneous rock phosphate;
c) gypsum;
d) a binder; and
e) water;
ii. pelletizing the mixture to obtain a pellet; and
iii. drying the pellet until the moisture content is less than or equal to 8%.

44. The pelleted composition produced according the method of claim 43.

45. A method of producing a pelleted composition comprising:
i. uniformly mixing a mixture comprising:
a) a combination of limestone and leonardite which has been developed for at least two weeks;
b) gypsum;
c) a binder; and
d) water;
ii. pelletizing the mixture to obtain a pellet; and
iii. drying the pellet until the moisture content is less than or equal to 8%.

46. A pelleted composition produced according the method of claim 45.

47. A method of producing a stable pelleted composition comprising:
a) combining leonardite with an amendment selected from the group consisting of limestone and sedimentary rock phosphate, to yield a mixture;
b) allowing the mixture to develop for at least about 2 weeks to yield a developed mixture;
c) combining the developed mixture with gypsum;
d) adding an aqueous binder in an amount sufficient to bind the developed mixture to yield a resultant mixture;
e) pelletizing the resultant mixture to obtain a pellet; and
f) drying the pellet at a temperature of less than about 200° C.

48. The method of claim 47, wherein the amendment is limestone.

49. The method of claim 47, wherein the amendment is sedimentary rock phosphate and wherein step c) further comprises combining the developed mixture with igneous rock phosphate.

50. A pelleted composition produced according the method of claim 47.

51. A pelleted composition produced according the method of claim 48.

52. A pelleted composition produced according the method of claim 49.
